(19) United States
(12) Patent Application Publication
(10) Pub. No.: US 2026/0001020 A1
(43) Pub. Date: Jan. 1, 2026

(54) A FILTER MEDIA SUPPORTING CAGE ASSEMBLY AND ARRANGEMENTS INCLUDING SUCH CAGE ASSEMBLY

(71) Applicant: Camfil Aktiebolag, Stockholm (SE)

(72) Inventors: Frank SEALES, Lachine (CA); Mikael NILSSON, Brämhult (SE); Martin LUNDBLAD, Södertälje (SE); Gautam MARWAHA, Laval (CA); Randilyne HUCKABY, Jonesboro, AR (US); Mathieu HUGUES, Vagnhärad (SE); Michelle BOURBONNAIS-SPEAR, Terrebonne (CA); Rose AVEDISSIAN, Laval (CA); Kenny HEDLUND, Trosa (SE)

(21) Appl. No.: 18/881,521

(22) PCT Filed: Jul. 7, 2023
(86) PCT No.: PCT/SE2023/050720

§ 371 Date: Jan. 6, 2025

(30) Foreign Application Priority Data
Jul. 11, 2022 (SE) 2250890-7

(51) Int. Cl. B01D 46/00; B01D 46/24; B01D 46/71

(52) U.S. Cl. CPC B01D 46/0005; B01D 46/0045; B01D 46/2411; B01D 46/71

(57) ABSTRACT

A filter media supporting cage assembly (1) for a filter media support structure (100) configured to support a filter media pack (101) in a filter cartridge (110), said cage assembly (1) circumscribing an interior volume (V) and comprising two or more cage wall members (4) extending in a length direction (L) from a first end (2) to a second end (3), each of said cage wall members (4) having an inner side (5) facing the interior volume (V), when assembled, and an outer side (6) facing the filter media pack (101), when mounted in a filter cartridge, and said cage assembly (1) having a latticework structure including column elements (7) extending substantially in said length direction (L) and beam elements (8) extending in a cage circumference direction, and said cage wall members comprising one or more column connecting sections (11) extending in a cage circumference direction and including column connecting sheet elements (12) located between and attached to adjacent column elements (7) and extending in said length direction (L). A filter media support structure (100), A filter cartridge (110) and an air filtration arrangement (120) including a filter cartridge.

### TECHNICAL FIELD

The present disclosure pertains to the technical field of air filters in which a filter media pack is supported by a cage structure.

### BACKGROUND ART

Hollow air filters typically include some kind of arrangement to hold the filter media, such as cage placed inside and supporting a hollow air filter media pack. The cage is often made of rolled steel netting, which can provide sufficient stability and is economical due to the round shape. However, there is a continuous desire to improve performance and reduce cost within air filtration, and there is thus a need for improved air filters that show sufficient stability and are easy to manufacture.

### SUMMARY

The present disclosure aims at providing a filter media support structure configured to support a filter media pack in a filter cartridge which has high strength and is easy to manufacture. Thus, there is provided a filter media supporting cage assembly for a filter media support structure configured to support a filter media pack in a filter cartridge, the cage assembly circumscribing an interior volume and comprising two or more cage wall members extending in a length direction from a first end to a second end, each of the cage wall members having an inner side facing the interior volume, when assembled, and an outer side facing the filter media pack, when mounted in a filter cartridge, and the cage assembly having a latticework structure including column elements extending substantially in the length direction and beam elements extending in a cage circumference direction, and the cage wall members comprising one or more column connecting sections extending in a cage circumference direction and including column connecting sheet elements located between and attached to adjacent column elements and extending in the length direction. The cage assembly may suitably be adapted to be included in a pulse filter media support structure, configured to support a pulse filter media pack in a pulse filter cartridge, and may be tapered so as to be narrower at the first end than at the second end. The column elements may extend in a cross-wall direction from said inner side to said outer side of the cage wall member and having a width in the cross-wall direction and a thickness in the cage circumference direction, where the width is 1.5-50 times larger than the thickness, preferably 2-25, more preferably 3-10. The beam elements may preferably be located at the outer side of the cage wall members.

The column connecting sheet elements preferably extend substantially in said length direction and from the inner side of the cage wall member to the outer side of the cage wall member in a direction toward said first end, and wherein the column connecting sheet elements preferably has length from a first edge to a second edge that is at least 4 times greater than the thickness of the column connecting sheet elements, and they may suitably include a curved portion located toward said first end of the cage wall member, thus being configured to direct air flow through the cage during use of the filter cartridge. The column connecting sheet elements may further preferably have an angle of attack with respect to an air flow entering the cage radially through the cage wall, said angle of attack being between 5° and 85° degrees, said angle of attack being the angle between the radial direction of the cage and a straight line connecting a first edge and a second edge of the column connecting sheet elements. The beam elements may be an integrated part of the column connecting sheet elements or may be separate from said column connecting sheet elements. The beam elements may extend in a cage circumference direction substantially perpendicular to length direction. The cage wall members may further include one or more cross bracing sections extending in a cage circumference direction and including inclined cross bracing elements extending between adjacent column elements.

The cage wall members of the cage assembly may advantageously be held together by one or more retaining rings. The cage wall members may be configured to align to, or interlock with, each other to form the cage. Suitably, all cage wall members may have substantially the same shape. The cage assembly may advantageously comprise four cage wall members, the wall members preferably being substantially flat. Further, one or more of the cage wall members may include two or more notches located on said inner side of the cage wall member along a centre-line extending in the length direction of the cage wall member, and the notches may preferably be located in said column connecting sections. The cage wall members may advantageously be made of corrosion resistant material, preferably plastic material or polymer composite material. The cage wall members are preferably integral pieces, most preferably obtained by injection molding.

The present disclosure also relates to a filter media support structure comprising a filter media supporting cage assembly described above, and a first end plate attached at a first end of the cage assembly and a second end plate attached at a second end of the cage assembly, the first end plate being closed, or having an opening for air flow out of or into the interior volume of the cage assembly, and the second end plate having an opening for air flow out of or into the interior volume of the cage assembly, the filter media support structure preferably including one or more corner brackets arranged in the opening of the second end plate.

The present disclosure further relates to a filter cartridge comprising a filter support structure of the second aspect and a filter media pack, the filter cartridge preferably being a pulse filter cartridge.

Furthermore, there is provided an air filtration arrangement including the above filter cartridge, a mounting stand, and a filter cartridge abutment plate comprising an air flow opening, wherein filter cartridge is fastened to the mounting stand so that the filter cartridge is located over the opening and the second end plate abuts the filter cartridge abutment plate. The airfiltration arrangement may comprise two filter cartridges mounted on top of each other, wherein the first end plate of one filter cartridge has an opening for air flow out of or into the interior volume, and the other filter cartridge has a closed first end plate.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed invention is not limited to the particular component parts of the device described since such device may vary. It is also to be understood that the terminology used herein is for the purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings do not exclude other elements or steps.

### DETAILED DESCRIPTION

The present disclosure aims at providing a filter media support structure, which has high strength and is easy to manufacture and is configured to support a filter media pack in a filter cartridge. Thus, there is provided a filter media supporting cage assembly for a filter media support structure configured to support a filter media pack in a filter cartridge, which has a configuration that gives sufficient strength and stability, and which is simple and effective to manufacture.

The cage assembly can be used in different kinds of hollow filters, where an air flow is directed from the outside of the filter media pack toward the interior volume, or from the interior of the filter media pack toward the outside. The cage assembly may advantageously be included in a pulse filter media support structure, configured to support a pulse filter media pack in a pulse filter cartridge, since the strength and stability of the cage assembly can withstand the forces of the filtration air flow and the pulse air flow that has the opposite flow direction.

The cage assembly circumscribes an interior volume and comprises two or more cage wall members extending in a length direction from a first end to a second end. The two or more cage wall members can be designed to be very easy to assemble, as will be described in more detail below. Each of the cage wall members have an inner side facing the interior volume when assembled, and an outer side facing the filter media pack when mounted in a filter cartridge. The wall members have a latticework structure including column elements and beam elements, where the column elements provide stability in the length direction of the cage assembly and the beam elements connect the column elements and provide strength and stability in a circumferential direction. The column elements extend substantially in the length direction, i.e., they generally extend from the first end to the second end of the wall member but need not be parallel with each other or with the length direction of the wall member. Each wall member can include two or more column elements, depending on the size of the filter media pack to be supported by the cage assembly, and may include for example 6-10 column elements. The distance between adjacent column elements may be dependent on the number of column elements and the circumferential width of the cage wall member. When the cage assembly is used in a pulse filter cartridge which is adapted to be installed on a mounting stand, such as a tripod, the column elements of the wall members will also support the axial load exerted on the filter cage assembly when it is installed.

The beam elements extend in a cage circumference direction, i.e., they generally extend from one side of the wall member to the other side and can be arranged in a direction perpendicular to the length direction of the wall member or can be inclined at angle between the length direction and the direction perpendicular to the length direction.

The cage wall members further comprise one or more column connecting sections as a part of the latticework, which extend in a cage circumference direction, and which can, similarly to the beam elements, be arranged in a direction perpendicular to the length direction of the wall member or can be inclined at angle between the length direction and the direction perpendicular to the length direction. The column connecting sections include column connecting sheet elements, which are located between and attached to adjacent column elements and extend in the length direction. The column connecting sheet elements and the beam elements can thus be arranged to connect the column elements at multiple points and thereby serve to stabilize the cage assembly, while still allowing an air flow to pass.

The filter media pack can be of any suitable type and may typically be a hollow structure where a pleated filter media pack extend in the circumference direction and, where the pleats extend in the length direction of the cage wall members.

The column elements may extend in a cross-wall direction from said inner side to said outer side of the cage wall member and can have a width in the cross-wall direction (radially) that is larger than a thickness in the cage circumference direction, for example, the width may be 1.5-50 times larger than the thickness, preferably 2-25, more preferably 3-10. This means that there will be a distance between the inside and the outside of the cage assembly that is at least 1.5 times the thickness of each individual column element, which improves the strength of the case assembly and reduces the risk of buckling in the radial direction during use. The column elements may suitably have a width in the cross-wall direction of at least 10 mm.

The beam elements may preferably be located at the outer side of the cage wall members, preferably level with the outward side of the column elements. This allows the beam elements to support the filter media pack, and the transverse direction of the beam elements prevents the pleats of a pleated filter media pack from slipping around the column elements. Further this location of the beam elements allows the column connecting sheet elements to be located inside of the outer side of the cage assembly.

The column connecting sheet elements preferably extend substantially in the length direction of the wall members, and thus connect to the column elements along their full length. As the column connecting sheet elements are in connection with a column element on each side along their full length, the stability of the cage assembly is improved. Further, the column connecting sheet elements preferably also extend from the inner side of the cage wall member to the outer side thereof in a direction toward said first end, so that they have a first edge with respect to an airflow directed from the outside of the cage assembly toward the interior volume that is located at or near the outer side of the cage assembly, and a second edge that is located at or near the inside of the cage assembly. Thus, with respect to an air flow directed from the outside of the cage assembly toward the interior volume, the first edge will be a leading edge and the second edge will be a trailing edge, and with respect to an air flow directed from an air passage opening at the second end of the cage assembly, the second edge (located at or near the inside of the cage assembly) will be the leading edge and the first edge (located at or near the outer side of the cage assembly) will be the trailing edge. Consequently, the column connecting sheet elements are arranged in a tilted manner, so that they can act as vanes, which improves the air flow through the filter cartridge, by redirecting the air flow from a radial direction by which it enters the filter media pack and the cage assembly to an axial direction by which it leaves the interior volume of the filter cartridge through the second end of the cage assembly. The column connecting sheet elements may have length from the first edge to the second edge that is at least 4 times greater than the thickness of the column connecting sheet elements, so that the air flow can easily pass and change direction through the cage assembly. When the first edge of the column connecting sheet elements is located level with the outer side of the cage it can assist in supporting the filter media pack.

The column connecting sheet elements may further suitably include a curved portion located toward said first end of the cage wall member, thus being configured to direct air flow through the cage during use of the filter cartridge, which further improves the air flow in both directions through the cage and filter media pack, and in the case of a pulse filter also results in a better pulse effect.

The column connecting sheet elements may further preferably have an angle of attack with respect to an air flow entering the cage radially through the cage wall, said angle of attack being between 5° and 85° degrees, said angle of attack being the angle between the radial direction of the cage and a straight line connecting a first edge and a second edge of the column connecting sheet elements. The column connecting sheet elements may be curved and positioned so that they present a concave surface both toward an air flow entering the air filter cartridge radially through the filter media, and toward an air flow entering the air filter cartridge from an axial direction through the second open end.

The wall members of the cage assembly may include alternating sections of beam elements and column connecting sections including column connecting sheet elements, in which case the beam elements are separate from the column connecting sheet elements.

Alternatively, the beam elements may be an integrated part of the column connecting sheet elements and be in the form of a beam part at the first end of the column connecting sheet elements located at the outer side of the wall members, preferably level with the outward side of the column elements.

The column connecting sections can be arranged in a circumferential direction of the cage assembly, which is substantially perpendicular to the length direction of the wall members, whereby the column connecting sheet elements of one column connecting section may be located side by side at the same length position of the wall member.

Alternatively, the column connecting sections can be arranged in a circumferential direction of the cage assembly, which is at an angle to the length direction of the wall members, whereby the column connecting sheet elements between adjacent column elements may be located at different length positions of the wall member. The column connecting sections on each side of a longitudinal center line of the wall member may be inclined in different directions to form e.g. a fish bone or feather configuration.

The cage wall members may further include one or more cross bracing sections, as a part of the latticework, extending in a cage circumference direction, which may be perpendicular or at an angle to the length direction of the wall member, and include inclined cross bracing elements extending between adjacent column elements, which may additionally decrease the risk of buckling of the cage during use.

The wall members may preferably be substantially flat, i.e. entirely flat or only slightly curved in a circumferential direction.

The cage wall members may advantageously be made of corrosion resistant material, preferably plastic material or polymer composite material, which may be advantageous when operating the filter in corrosive environment. Plastic material or polymer composite material has the further advantage of having low weight, as compared e.g. to metal such as steel, and allows effective manufacture, since complicated shapes can be integrated in the wall member. For example, non-reinforced or reinforced ABS may be used.

Each cage wall member is preferably an integral piece, which may advantageously be obtained by injection molding. Forming the cage from two or more wall members, which all extend along the entire length of the cage and are assembled to a cage at their sides, allows for easier manufacture of the cage, since the wall members can be made by injection molding, such that they can be made of plastic material. The wall members are then assembled to a cage having a structure which may be difficult to obtain from plastic material in a one-piece structure.

Injection molding is an effective and low-cost manufacturing method, resulting in a strong wall member that can be obtained in one step, and the various latticework elements need not be joined in separate steps. Accordingly, this allows the wall members to have a complicated construction, while still being easy to manufacture.

In comparison, in the prior art hollow one-piece filter supporting structures may have been obtained for example by extrusion, but this method would not allow the resulting filter supporting structure to have a complicated design, such as that of the cage according to the present invention, including column elements and beam elements, as well as circumferential column connecting sections and column connecting sheet elements located between and attached to adjacent column elements.

All cage wall members of a cage assembly may suitably have substantially the same shape, i.e. the same latticework configuration, so that they can be manufactured in the same mold and can be stacked for effective transport. In order to allow simple assembly, the cage wall members may suitably be configured to align to, or interlock with, each other to form the cage. Various alternatives for connection elements for connecting the wall members can be contemplated, e.g. the wall members can have entirely flat sides that abut each other when mounted, or interlocking shapes such as corresponding protrusions and recesses can be provided on the side surfaces of the wall members. Assembly of the cage can be facilitated by providing a retaining ring that holds the wall members together during mounting in a filter support structure including the cage assembly. A retaining ring can also improve cage strength in a radial direction.

The cage assembly may advantageously comprise four substantially flat cage wall members. Thereby a substantially square or rectangular cross-section transverse to the length direction of the cage assembly can be obtained. A square cage assembly will have a larger opening and a larger total cage filter area compared to a cage assembly with a circular cross section, which leads to decreased pressure drop. Because all of the connecting elements that can act as vanes and are integrated into the inner cage, the air passing through the filter is better directed to the filter outlet, and therefore decreases the pressure drop.

The wall members may be tapered so that the cage assembly is narrower at the first end than at the second end when mounted, in order to facilitate installation in air filter arrangement where there is limited space or obstructions in the way and may improve the air flow through the filter media pack, in particular when a pleated filter media pack is used. In a tapered cage, the connecting elements that can act as air flow guiding vanes may have an additional pulse air flow guiding effect in that they may gradually “cut off” or “slice off” parts of the pulse air flow pulse as it enters via the open end of the cartridge (FIG. 15), such that the kinetic energy transforms into static pressure already in the compartments made up of a vane and adjacent beam sides and towards the media pack.

When mounting a tapered cage assembly, the use of a retaining ring is particularly advantageous, since the retaining ring can just be slipped over the top of the cage to reach a position where the circumference of the cage assembly corresponds to the size of the retaining ring. Preferably, the retaining ring is configured to fit the cage assembly circumference in a position approximately halfway along the cage length.

Further, one or more of the cage wall members may include two or more notches located along a center-line extending in the length direction on the inner side of the cage wall member. When mounting the cage assembly on a mounting stand, the notches can facilitate correct positioning of the cage assembly on the mounting stand, in particular when the cage assembly has a non-circular cross section. For example, when mounting a square cage assembly on a tripod mounting stand, the notches can engage with an uppermost tripod leg to get the cage assembly in correct position. The notches may preferably be located in within the column connecting sections of the cage wall members.

The above cage assembly is intended for inclusion in a filter media support structure together with a first and a second end plate. The first end plate is attached at a first end of the cage assembly and can be closed or can have an opening for air flow out of or into the interior volume of the cage assembly. The second end plate is attached at a second end of the cage assembly, the second end plate having an opening for air flow out of or into the interior volume of the cage assembly. The first and second end plates include attachment portions that are configured to interlock with the first and second ends, respectively, of the cage assembly, and further include filter media pack retaining portions extending radially outward from the cage assembly, and receiving surfaces are configured to receive the ends of a hollow filter media pack. The filter media pack is suitably attached and sealed to the end plates by a suitable adhesive. The end plates may be provided with a centering ramp that is configured to fit into the cage to facilitate assembly. Corner brackets may be arranged in the opening of the second end plate, and may facilitate positioning of a non-circular cage assembly on a mounting stand as it prevents the support structure from hanging on a corner on the mounting stand and thus prevents the mounting stand from getting stuck in a corner of the support structure.

A filter cartridge according to the present disclosure comprises a filter support structure as described above and a filter media pack. The filter cartridge may be particularly useful as a pulse filter cartridge. If desired, two filter cartridges may be assembled to form a longer filter cartridge assembly, which will then comprise two filter support structures mounted on top of each other, with filter media packs held between the end plates of each support structure. In this case the support structures, and consequently, the cage assemblies have different sizes so that the size of the first end plate of one support structure matches the size of the second end plate of the other support structure. The first end plate of one support structure may then have an opening for air flow out of or into the interior volume and will be placed adjacent to the second end plate of and the other support structure may have a closed first end plate. The cartridge assembly will thereby have a total interior reaching from the second end of one support structure to the closed end of the other support structure. If desired more than two support structures can be included in the cartridge assembly in a similar manner.

As mentioned above the cage of the present invention and the filter cartridge comprising the cage may be particularly useful in a pulse filter. Pulse air filters are commonly used in industrial applications to remove particulate matter from air or gas streams. They operate based on the principle of using short bursts of compressed air to clean the filter elements. The operation of a pulse air filter generally includes a filtration stage and a cleaning stage. In the filtration stage, the polluted air or gas containing particles enters a filtration chamber of the filter system. The chamber typically contains multiple filter elements, which are typically cylindrical cartridges or bags made of porous filter media material. As the air passes through the filter elements, the particles present in the air are trapped on the surface or within the porous structure of the filter media. The filter elements gradually accumulate the captured particulate matter, which leads to increased pressure drop and energy consumption.

To maintain the filter's performance and prevent excessive pressure drop across the elements, periodic cleaning is necessary. This is where the air pulse mechanism comes into play. The cleaning stage involves releasing a pulse air flow of compressed air from one or more nozzles or blow pipes located above or within the filter elements on the clean side.

Pulse air filter cartridges typically have a construction wherein a hollow filter media pack is arranged such that a closed interior space is formed, inside the filter media pack. When a pulse air flow enters the interior of a hollow air filter cartridge from an open end of the filter cartridge, i.e. upstream of the filter media, the pulse air flow will take the easiest way. This means that the pulse airflow will first reach the closed end of the interior space before changing direction and passing the filter media in a direction transverse to the filter media surface. The air flow of the compressed air pulse has a very high velocity, typically around 300 m/s or more, and consequently has a very high kinetic energy. When the pulse air flow reaches the closed end of the pulse filter cartridge, it is stopped and the kinetic energy is transformed into static pressure. The static pressure will be very high in the vicinity of the closed end of the filter cartridge, and the pressure within the interior of the filter media pack will thus instantly be substantially higher than the pressure on the outside of the filter media pack. The pulse of compressed air thus creates a reverse airflow within the filter elements. This is schematically illustrated in FIGS. 13-15. The sudden increase in pressure and velocity causes the filter media to flex and vibrate, dislodging the accumulated particulate matter from the surface, from the surface of fibers within the media structure or within pores. The particles are then shaken off and fall into a collection hopper or bin located beneath the filter chamber or directly towards the ground it the pulse filters are located as the first stage of an air intake. After the pulse cleaning stage, the pulse air filter can again enter a filtration stage.

In conventional pulse air filters, the pulse effect, and thus the cleaning, will be most effective near the closed end of the pulse air filter cartridge, as schematically illustrated in FIG. 13. However, a part of the static pressure energy will propagate and cause an increased static pressure further backward in the cartridge, i.e. closer to the open end of the cartridge. This effect will diminish in direction toward the open end of the pulse air filter cartridge.

There is a desire to obtain a more even and thus effective pulse effect over the entire filter media pack. This is solved according to the present disclosure by the arrangement of connecting elements that can act as air flow guiding vanes on the upstream side of the filter media pack with respect to the pulse air flow direction. The presence of air flow guiding vanes may contribute to improved pulse effect by partially blocking the passage through the filter media in the radial direction, thus increasing the proportion of the static pressure propagating backwards toward the open end of the cartridge, such that the high static pressure inside the filter media pack becomes more evenly distributed in the interior volume of the filter cartridge during the pulse, and the pulse cleaning will be more effective over the entire filter media pack. The vanes thus guide the pulse air flow so as to be appropriately distributed over the filter media before it is allowed to pass through the filter media and blow off particles captured thereby (FIGS. 14-15). At the same time, the air flow guiding vanes have a shape that does not hinder the air flow or increase pressure drop during the filtration stage. During the pulse, the compressed air flow may force the filter media in a downstream direction, which can damage the media pack unless precautionary measures are taken. The pulse air filter cartridge may therefore suitably comprise an exterior support structure arranged around the exterior periphery of the filter media pack, to keep the filter media pack in place during the cleaning stage, preventing the air pulse from blowing off and destroying the filter media pack. The exterior support structure may preferably comprise a string or wire wound or coiled around the filter media pack, or a net wrapped around the media pack, or one or more rings placed over the periphery of the filter media pack. The exterior support structure may be made from any suitable material such as metal or plastic.

Furthermore, there is provided an air filtration arrangement including the above filter cartridge or cartridge assembly, a mounting stand, and a filter cartridge abutment plate comprising an air flow opening, wherein filter cartridge is fastened to the mounting stand so that the filter cartridge is located over the opening and the second end plate abuts the filter cartridge abutment plate.

### BRIEF DESCRIPTIONS OF THE DRAWINGS

The above objects, features and advantages of the present disclosure, will be more fully appreciated by reference to the following illustrative and non-limiting description of example embodiments of the present disclosure, when taken in conjunction with the accompanying drawings.

FIG. 1 shows a cage wall member of the cage assembly of the present disclosure;

FIG. 2 is a side view of the cage wall member of FIG. 1;

FIG. 3 shows a cage assembly seen from the second end thereof;

FIG. 4 shows a detail of a wall member with a column connecting sheet element;

FIG. 5 shows a support structure of the present disclosure including a cage assembly and end plates;

FIG. 6 shows the support structure of FIG. 5 seen from the second end thereof;

FIG. 7 shows a filter cartridge including a support structure and a filter media pack;

FIG. 8 shows a support structure with a closed first end plate;

FIG. 9 shows a wall member in an alternative configuration;

FIG. 10 shows a filter cartridge including two support structures on top of each other;

FIG. 11 shows an air filter arrangement including a filter cartridge of the present disclosure.

FIG. 12 shows the air filter arrangement of FIG. 10, with an exterior support structure arranged on the outside;

FIG. 13 schematically illustrates the pulse air flow in a conventional pulse air filter cartridge;

FIGS. 14 and 15 schematically illustrate the pulse air flow in pulse air filter cartridges according to the present disclosure.

### EXAMPLE EMBODIMENTS

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

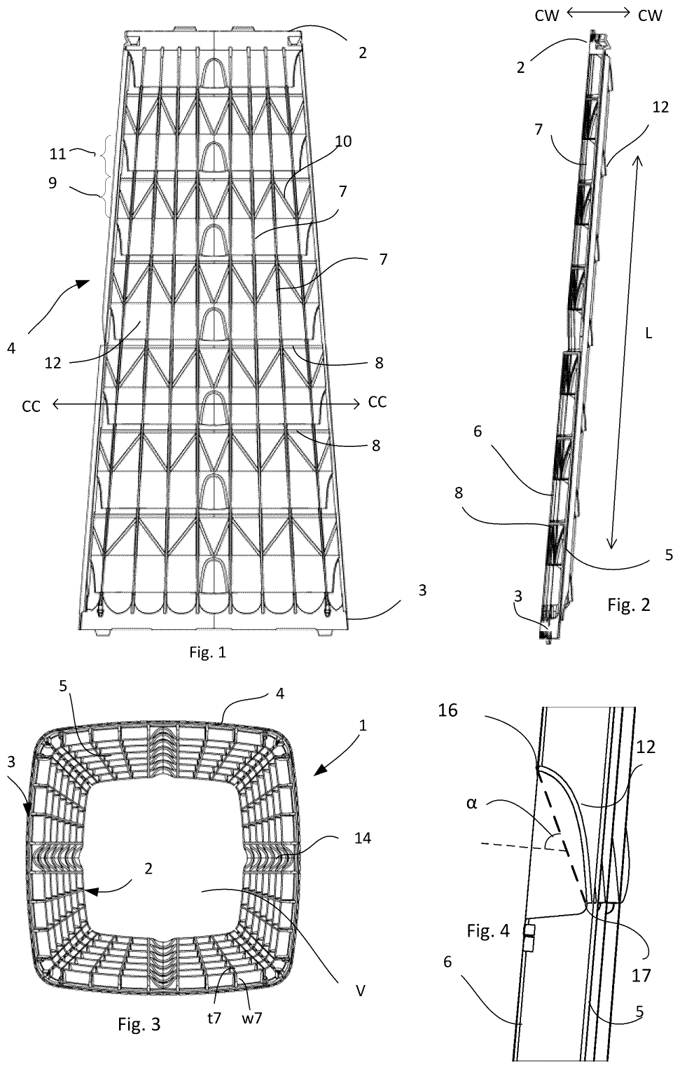

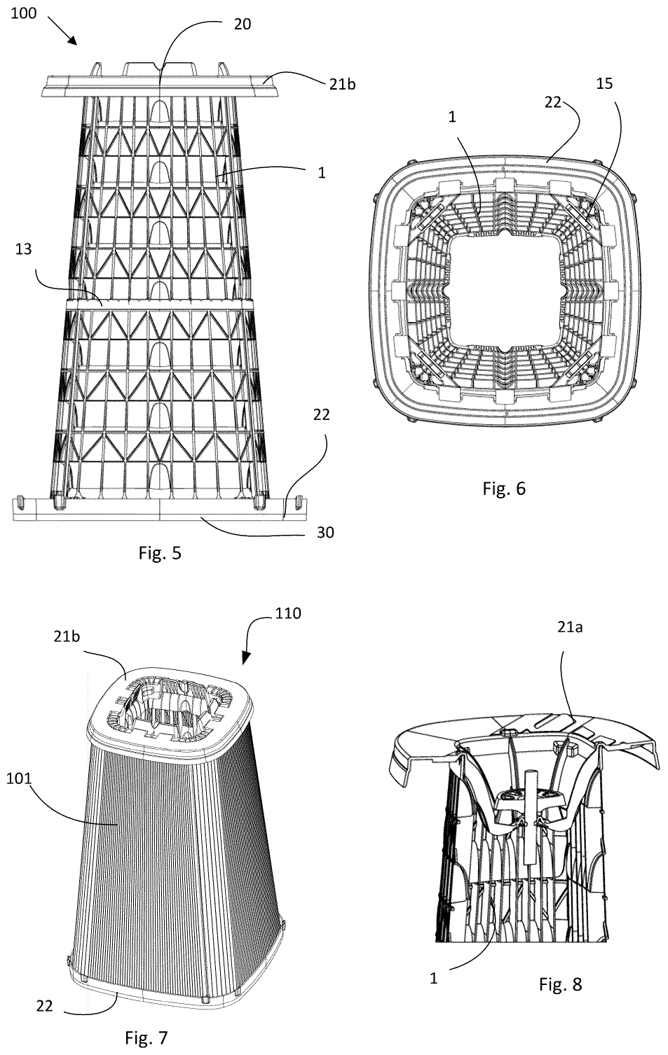

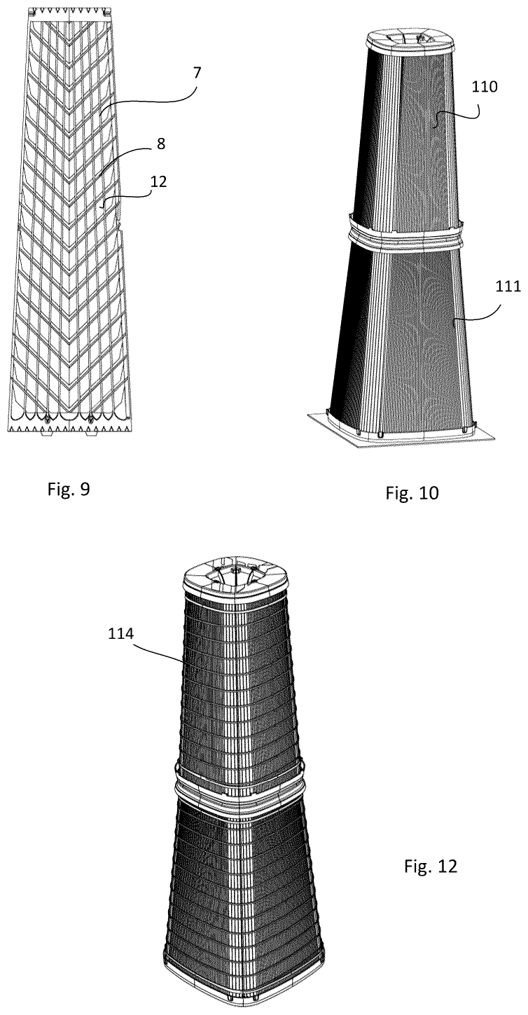

FIGS. 1-4 illustrate a filter media supporting cage assembly 1 according to the present disclosure and details thereof. The cage assembly is intended to be included in a filter media support structure 100 (FIGS. 5-6) configured to support a filter media pack 101 in a filter cartridge 110 (FIG. 7). FIG. 9 illustrates an alternative configuration of a wall member for use in a cage assembly of the present disclosure. The cage assembly 1 circumscribes an interior volume V and comprises four cage wall members 4, in the shown example. The wall members 4 extend in a length direction L from a first end 2 to a second end 3. Each cage wall member 4 has an inner side 5 facing the interior volume V, when assembled, and an outer side 6 facing the filter media pack 101, when mounted in a filter cartridge. As seen best in FIGS. 1, 5 and 8, the cage assembly 1 has a latticework structure including column elements 7 extending substantially in the length direction L and beam elements 8 extending in a cage circumference direction. The cage wall members comprise column connecting sections 11 extending in a cage circumference direction, which include column connecting sheet elements 12 located between and attached to adjacent column elements 7 and extending in the length direction L. In the shown examples, the cage assembly 1 is tapered so as to be narrower at the first end 2 than at the second end 3.

The column elements 7 extend in a cross-wall direction CW from the inner side 5 to the outer side 6 of the cage wall member. They have a width w7 in the cross-wall direction and a thickness t7 in the cage circumference direction, where the width w7 is 1.5-50 times larger than the thickness t7, preferably 2-25, more preferably 3-10. In the shown examples, the beam elements 8 are located at the outer side of the cage wall members 4.

The column connecting sheet elements 12 extend substantially in said length direction L, and from the inner side 5 of the cage wall member to the outer side 6 of the cage wall member in a direction toward said first end 2. The column connecting sheet elements 12 have length from the first edge 16 to the second edge 17 that is at least 4 times greater than the thickness of the column connecting sheet elements. As illustrated in FIG. 4, the column connecting sheet elements 12 may include a curved portion located toward the first end 2 of the cage wall member, thus being configured to direct air flow through the cage during use of the filter cartridge. The column connecting sheet elements 12 have an angle of attack with respect to an air flow entering the cage radially through the cage wall, which is between 5° and 85° degrees. The angle of attack is the angle between a direction perpendicular to the outer side 6 and of the cage and a straight line connecting a first edge 16 and a second edge 17 of the column connecting sheet elements.

In the example of FIGS. 1-6, the beam elements 8 are separate from the column connecting sheet elements 12 and extend in a cage circumference direction substantially perpendicular to length direction L. in this example, the cage wall members also include cross bracing sections 9 extending in a cage circumference direction, which include inclined cross bracing elements 10 extending between adjacent column elements 7.

In the example of FIG. 9, the beam elements 8 are an integrated part of the column connecting sheet elements 12.

FIG. 5 shows how the cage wall members are held together by a retaining ring 13. The cage wall members 4 are configured to align to, or interlock with, each other so to form the cage.

In the illustrated examples, all cage wall members 4 of the cage assembly have substantially the same shape, and the cage assembly comprises four substantially flat cage wall members.

As seen in FIGS. 1, 3, 5, and 6, the cage wall members can include two or more notches 14 located on said inner side of the cage wall member along a centre-line extending in the length direction of the cage wall member. The notches 14 are located in said column connecting sections 11.

FIGS. 5, 6 and 8 show a filter media support structure comprising a filter media supporting cage assembly 1, a first end plate 21a, 21b attached at a first end 20 of the cage assembly and a second end plate 22 attached at a second end 30 of the cage assembly. The first end plate 21a can be closed (FIG. 8). Alternatively, the first end plate 21b can have an opening for air flow out of or into the interior volume V of the cage assembly. The second end plate 22 has an opening for air flow out of or into the interior volume V of the cage assembly. FIG. 6 shows how corner brackets 15 can be arranged in the opening of the second end plate 22.

FIG. 10 illustrates a filter comprising two filter support structures 100 of mounted on top of each other, wherein the first end plate 21b of one support structure has an opening for air flow out of or into the interior volume V, and the other support structure has a closed first end plate 21a, and wherein each filter support structure holds a filter media pack 101.

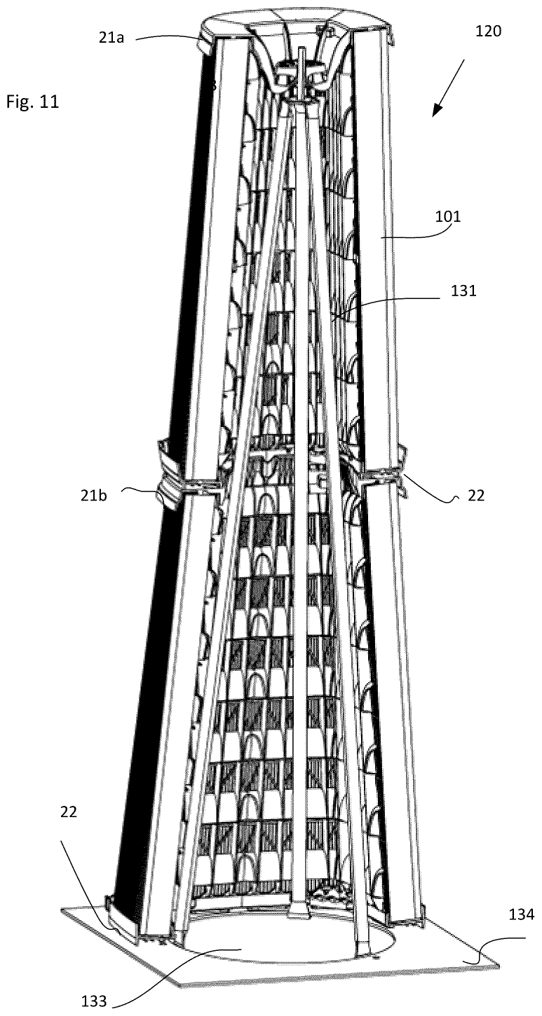

FIG. 11 shows an air filter arrangement including two filter cartridges 110 and 111 on top of each other, and illustrates an example of how the filter cartridge can be mounted in an air filter arrangement. The air filter arrangement is preferably a pulse filter arrangement. The supporting cage is arranged inside the hollow filter media pack 101, and a front end panel 21a closes the hollow air filter media at the front end thereof. A mounting stand 131 in the form of a tripod is attached oven an air passage opening 133 in a base plate 134. The two cartridges 110, 111 are placed over the tripod with the rear cartridge 111 closest to the opening 133, and its rear end plate 22 in abutment with the surface of the base plate 134. The front cartridge 110 is positioned so that its rear end plate 22 is in contact with the front end plate 21b of the rear cartridge 111. Other ways of mounting the air filter cartridges can be contemplated.

FIG. 12 shows the air filter arrangement of FIG. 10, with an exterior support structure (114) arranged on the outside, in the form of string coiled around the external surface of the media pack.

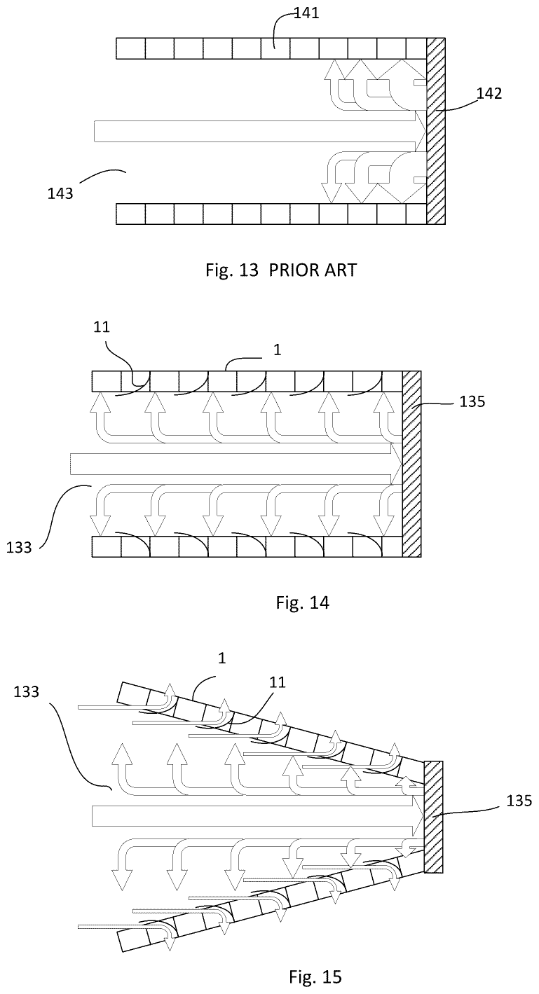

FIG. 13 schematically illustrates the pulse air flow in a conventional pulse air filter cartridge. In operation, during the pulse cleaning stage, the pulse of compressed enters the interior of a cage 141 at the open end 143 and a hollow filter media pack (not shown) and goes directly to the closed end 142 of the filter cartridge. The kinetic energy of the pulse is transformed into static pressure causing the air pulse to pass through the cage and filter media with the highest force close to the closed end 142.

FIGS. 14 and 15 schematically illustrate the pulse air flow in pulse air filter cartridges according to the present disclosure. Also here, the pulse of compressed enters the interior of the cage 1 at the open end 133 and the hollow filter media pack (not shown) and goes directly to the closed end 135 of the filter cartridge. In these cartridges, pulse air flow guiding vanes 11 are provided, which guide and distribute the pulse air flow more evenly over the filter media pack.

In addition, with a tapered cage, as shown in FIG. 15, a substantial part of the pulse air flow may also be cut off by the vanes 11, causing that part of the air pulse to pass through the filter media before it reaches the closed end 135. The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A filter media supporting cage assembly (1) for a filter media support structure (100) configured to support a filter media pack (101) in a filter cartridge (110), said cage assembly (1) circumscribing an interior volume (V), characterized in that the cage assembly comprises two or more cage wall members (4) extending in a length direction (L) from a first end (2) to a second end (3), each of said cage wall members (4) having an inner side (5) facing the interior volume (V), when assembled, and an outer side (6) facing the filter media pack (101), when mounted in a filter cartridge, and said cage assembly (1) having a latticework structure including column elements (7) extending substantially in said length direction (L) and beam elements (8) extending in a cage circumference direction, and said cage wall members comprising one or more column connecting sections (11) extending in a cage circumference direction and including column connecting sheet elements (12) located between and attached to adjacent column elements (7) and extending in said length direction (L).

2. The filter media supporting cage assembly of claim 1, wherein the cage assembly is adapted to be included in a pulse filter media support structure, configured to support a pulse filter media pack in a pulse filter cartridge.

3. The filter media supporting cage assembly of claim 1 or 2, wherein the cage assembly (1) is tapered so as to be narrower at the first end (2) than at the second end (3).

4. The filter media supporting cage assembly of any one of claims 1-3, wherein said column elements (7) extend in a cross-wall direction (CW) from said inner side (5) to said outer side (6) of the cage wall member and having a width (w7) in the cross-wall direction and a thickness (t7) in the cage circumference direction, where the width (w7) is 1.5-50 times larger than the thickness (t7), preferably 2-25, more preferably 3-10.

5. The filter media supporting cage assembly of any one of claims 1-4, wherein the beam elements (8) are located at the outer side of the cage wall members (4).

6. The filter media supporting cage assembly of any one of claims 1-5, wherein the column connecting sheet elements (12) extend substantially in said length direction (L) and from the inner side (5) of the cage wall member to the outer side (6) of the cage wall member in a direction toward said first end (2), and wherein the column connecting sheet elements (12) preferably has length from a first edge (16) to a second edge (17) that is at least 4 times greater than the thickness of the column connecting sheet elements.

7. The filter media supporting cage assembly of any one of claims 1-6, wherein the column connecting sheet elements (12) include a curved portion located toward said first end (2) of the cage wall member, thus being configured to direct air flow through the cage during use of the filter cartridge.

8. The filter media supporting cage assembly of any one of claims 1-7, wherein the column connecting sheet elements (12) have an angle of attack with respect to an air flow entering the cage radially through the cage wall, said angle of attack being between 5° and 85° degrees, said angle of attack being the angle between the radial direction of the cage and a straight line connecting a first edge (16) and a second edge (17) of the column connecting sheet elements.

9. The filter media supporting cage assembly of any one of claims 1-8, wherein the beam elements (8) are an integrated part of said column connecting sheet elements (12) or are separate from said column connecting sheet elements (12).

10. The filter media supporting cage assembly of any one of claims 1-9, wherein the beam elements (8) extend in a cage circumference direction substantially perpendicular to length direction (L).

11. The filter media supporting cage assembly of any one of claims 1-10, wherein the cage wall members include one or more cross bracing sections (9) extending in a cage circumference direction, and including inclined cross bracing elements (10) extending between adjacent column elements.

12. The filter media supporting cage assembly of any one of claims 1-11, wherein the cage wall members are held together by one or more retaining rings (14).

13. The filter media supporting cage assembly of any one of claims 1-12, wherein the cage wall members (4) are configured to align to, or interlock with, each other so to form the cage.

14. The filter media supporting cage assembly of any one of claims 1-13, wherein all cage wall members (4) have substantially the same shape.

15. The filter media supporting cage assembly of any one of claims 1-14, wherein the cage assembly comprises four cage wall members, the wall members preferably being substantially flat.

16. The filter media supporting cage assembly of any one of claims 1-15, wherein one or more of the cage wall members include two or more notches (14) located on said inner side of the cage wall member along a centre-line (C) extending in the length direction of the cage wall member.

17. The filter media supporting cage assembly of claim 16, wherein the notches (14) are located in said column connecting sections (11).

18. The filter media supporting cage assembly of any one of claims 1-17, wherein the cage wall members are made of corrosion resistant material, preferably plastic material or polymer composite material.

19. The filter media supporting cage assembly of any one of claims 1-18, wherein the cage wall members are integral pieces, preferably obtained by injection molding.

20. A filter media support structure (100) comprising a filter media supporting cage assembly (1) according to any one of claims 1-19, and a first end plate (21a, 21b) attached at a first end (20) of said cage assembly and a second end plate (22) attached at a second end (30) of said cage assembly, said first end plate being closed (21a), or having an opening (21b) for air flow out of or into the interior volume (V) of the cage assembly, and said second end plate (22) having an opening for air flow out of or into the interior volume (V) of the cage assembly, said filter media support structure preferably including one or more corner brackets (15) arranged in the opening of the second end plate (22).

21. A filter cartridge (110, 111) comprising a filter support structure (100) of claim 20 and a filter media pack (101), said filter cartridge preferably being a pulse filter cartridge.

22. An air filtration arrangement (120) including a filter cartridge of claim 21, a mounting stand (131), and a filter cartridge abutment plate (134) comprising an air flow opening (133), wherein filter cartridge is fastened to the mounting stand so that the filter cartridge is located over the opening (133) and the second end plate (22) abuts the filter cartridge abutment plate (134).

23. The air filtration arrangement of claim 22, comprising two filter cartridges (110, 111) of claim 21 mounted on top of each other, wherein the first end plate (21b) of one filter cartridge (111) has an opening for air flow out of or into the interior volume (V), and the other filter cartridge (110) has a closed first end plate (21a).
